(19) United States
(12) Patent Application Publication
(10) Pub. No.: US 2011/0114269 A1
(43) Pub. Date: May 19, 2011

(54) WINDOW COVERING FOR CONVENIENT CUTTING

(76) Inventor: Li-Ming CHENG, Kaohsiung City (TW)

(21) Appl. No.: 12/617,735

(22) Filed: Nov. 13, 2009

(51) Int. Cl. A47H 5/02; E06B 9/26; E06B 9/06

(52) U.S. Cl. 160/84.01; 160/340; 160/236; 160/166.1

(57) ABSTRACT

A window covering for convenient cutting includes an upper rail, a lower rail, a shade assembly, a lift cord means, an edging block and a removable coupling set installed on an outer side of the upper rail. The lift cord means has two lift cords laid outside the upper rail and passed through an engaging means located in the coupling set. The coupling set and the upper rail are latched through a latch portion and a channel. The width of the window covering can be cut at a desired length. Then the coupling set and the edging block can be installed on one side of the upper rail so that the widths of the upper rail and lower rail can fit the width of a targeted window or door. Cutting and installation of the window covering are easier.

### FIELD OF THE INVENTION

The present invention relates to a window covering for convenient cutting and particularly to a window covering that can be cut according to actual requirements and has a removable coupling set and an edging block mounted respectively on two sides of an upper rail of the window covering to facilitate installation and cutting.

### BACKGROUND OF THE INVENTION

The conventional window coverings now on the market such as Venetian blinds, pleated shades and the like mainly have an upper rail and a lower rail spaced from each other up and down and retractable slats interposed between the upper rail and the lower rail, and a lift cord or electronic remote control located on the window covering to control retraction or extension of the slats to block light or meet decorative purpose.

Many window coverings are installed by users after purchase. Some of them are ready for installation by the users. However, the window covering provided by the vendors often are limited to a few commonly used specifications. Hence even if users have measured the width of a targeted window or door where the window covering is to be installed prior to purchasing, there still could be dimensional differences between the two, such as the widths of the upper rail, lower rail and slats are slightly greater than the targeted window or door. Thus the users have to cut the excessive widths of the upper rail, lower rail and slats to fit the targeted window or door. Refer to FIGS. 1 and 2 for a conventional window covering 10 which has an upper rail 11, a lower rail 12 and slats 13, and also two lift cords 111 and 112 and an engaging means 113 located in the upper rail 11. While the upper rail 11 and lower rail 12 can be cut at one side slightly, to cut a greater length at one side will damage one of the lift cords, referring to FIG. 2. Hence both sides of the upper rail 11 and the lower rail 12 have to be cut (referring to dotted lines and arrows in FIG. 2). This results in different distances a and b between the lift cords 111 and 112 and the two sides. As a result, uneven forces are generated during retraction and extension of the window covering 10. Moreover, the cutoff upper rail 11 damages the appearance of the entire structure and the decorative appeal.

### SUMMARY OF THE INVENTION

Therefore, the primary objective of the present invention is to provide a window covering for convenient cutting with a removable coupling set and a lift cord threaded outside or inside the upper rail and movable so that the window covering can be cut and assembled to fit the width of a targeted window and door.

The window covering according to the invention includes an upper rail, a lower rail, a shade assembly and a lift cord means and a removable coupling set and an edging block respectively fastened to outer sides of the upper rail.

The upper rail is elongated and has a channel inside, and a first through hole and a second through hole formed on the top and bottom surfaces close to two ends thereof threaded through by the lift cord means.

The lower rail is spaced from the upper rail at a lower side.

The shade assembly is located between the upper rail and the lower rail.

The lift cord means includes a lift cord assembly which has two lift cords and one end fastened to the lower rail and the other end threading through the shade assembly and the upper rail and passing through an engaging means located in the coupling set.

The coupling set is fastened to one opening at one side of the channel of the upper rail and has a latch portion at one side facing the upper rail and a holding portion abutting the latch portion. In an embodiment of the invention, the holding portion is located on an outer side relative to the latch portion, and has a housing compartment and an orifice on an upper side leading to the housing compartment. The engaging means is held in the housing compartment. The engaging means has a roller located at one side of the housing compartment and a gear rack inclinedly located at the other side of the housing compartment engaging with a movable gear. The roller and movable gear form a passage between them to allow the two lift cords to pass through via the orifice. Hence the two lift cords can pass through between the movable gear and the roller without being clamped and be drawn freely. The movable gear also can be moved upwards to engage with the gear rack to clamp the two lift cords against the roller to form an anchor condition.

The construction set forth above can achieve the following effects: 1. The coupling set is fastened to one side of the upper rail and latched in the channel of the upper rail through the latch portion in a detachable manner, and the lift cords also can be moved outside the upper rail. All this makes cutting of the window covering to fit a selected door or window easier; 2. Cutting of the upper and lower rails can be done by users without relying on outside window covering providers. It can better fit total environment. Cutting and installation of the window covering also are simpler and can be done by the users themselves.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional window covering.

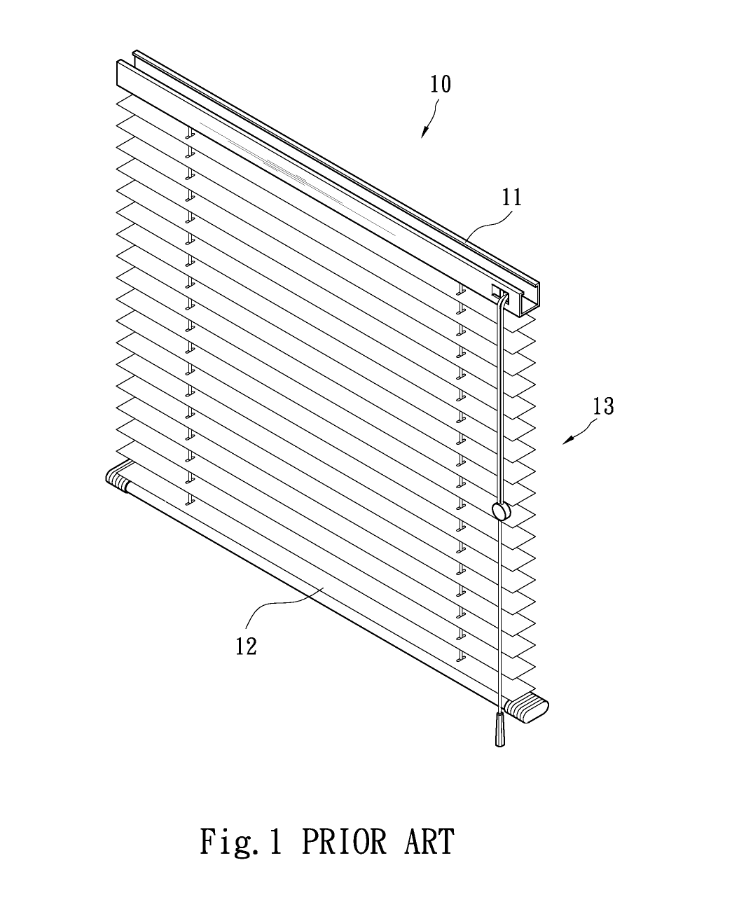

FIG. 2 is a top view of a conventional window covering under cutting.

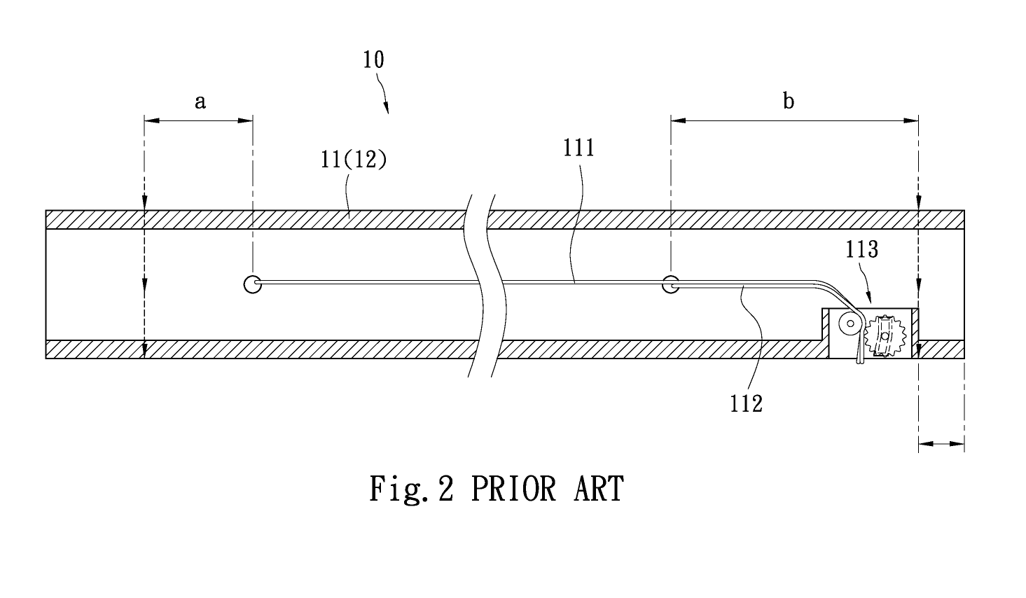

FIG. 3 is a perspective view of the invention.

FIG. 4A is an exploded view of the invention.

FIG. 4B is a cross section taken on line 4B-4B in FIG. 4A.

FIG. 5 is a schematic view of the engaging means of the invention clamping the lift cords.

FIG. 6 is an exploded view of another embodiment of the coupling set of the invention.

FIG. 7 is a perspective view according to FIG. 6 in an installation condition.

FIG. 8 is an exploded view of yet another embodiment of the invention.

### DETAILED DESCRIPTION OF THE PREFERRED EMBODIMENTS

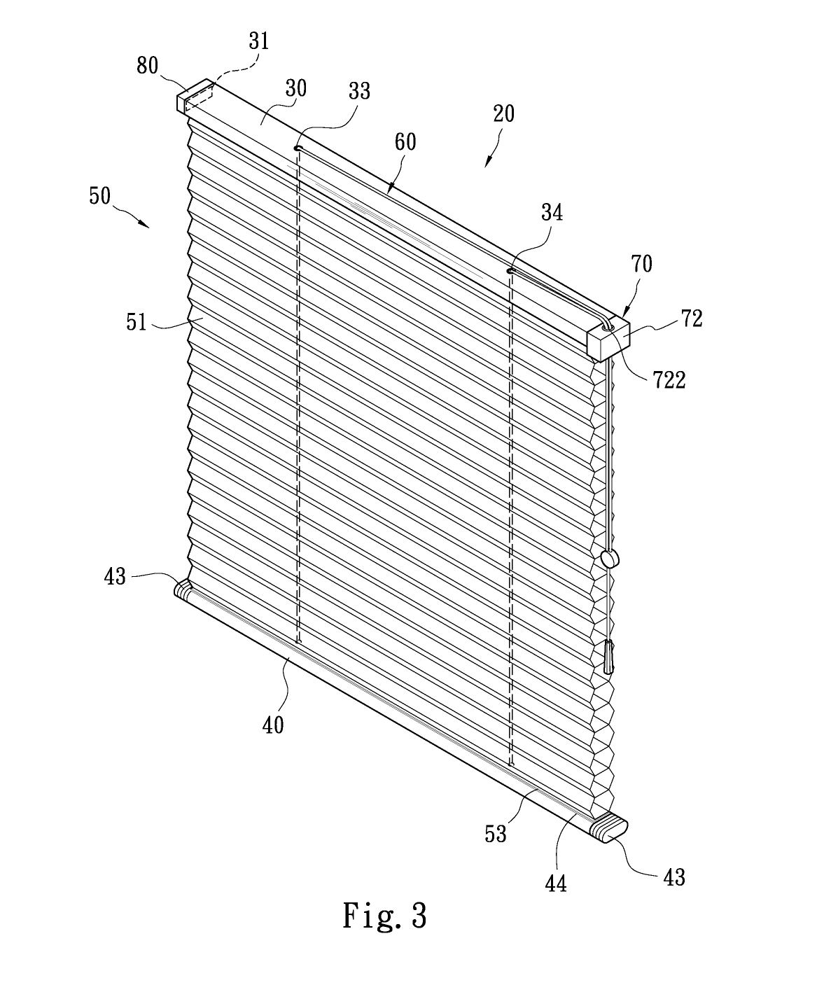

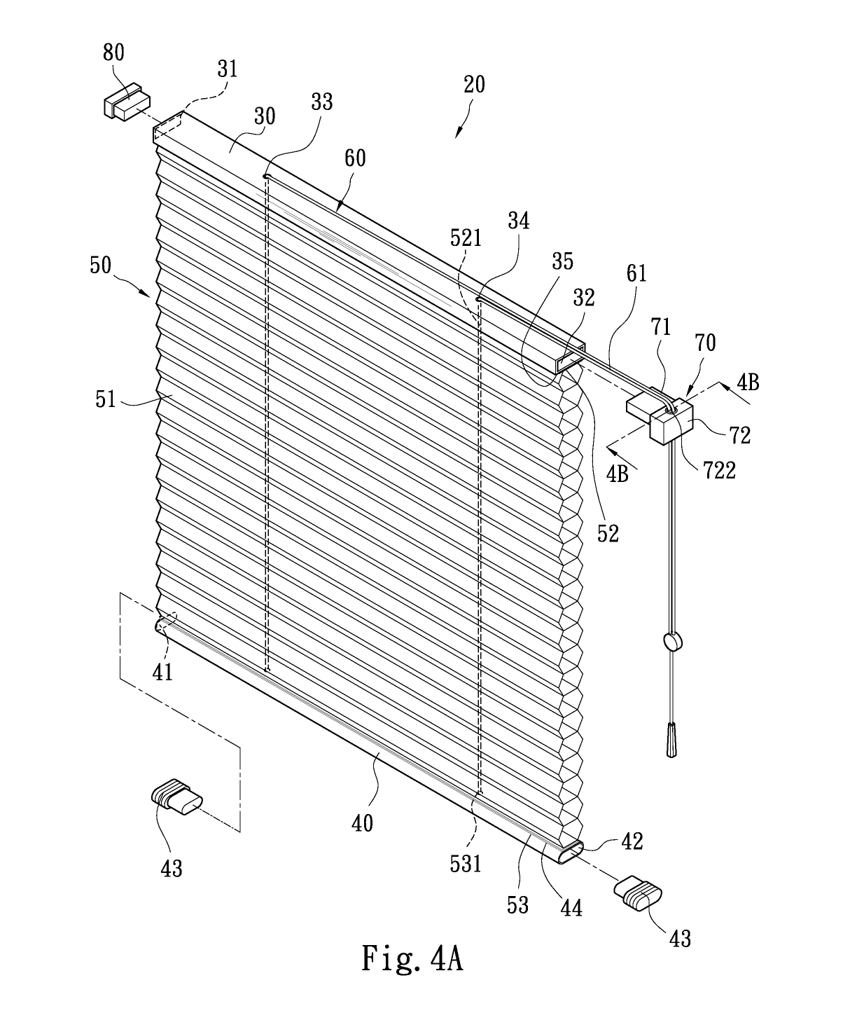

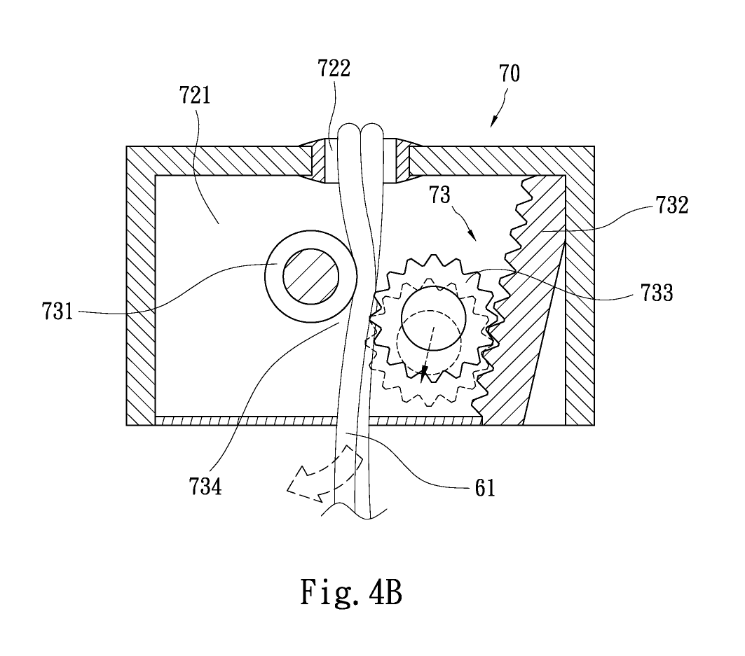

Please refer to FIGS. 3 and 4A, the window covering 20 according to the invention mainly includes an upper rail 30, a lower rail 40, a shade assembly 50, a lift cord means 60, a coupling set 70 and an edging block 80 fastened to outer sides of the upper rail 30 in a detachable manner.

The upper rail 30 is elongated and has a channel therein which has upper openings 31 and 32 at two ends with the opening 31 coupled with the edging block 80, and a first through hole 33 and a second through hole 34 formed on the top and bottom surfaces close to two ends thereof and threaded through by the lift cord means 60.

The lower rail 40 is spaced from the upper rail 30 at a lower side and is elongated with a channel formed inside and lower openings 41 and 42 at two ends are wedged in by corresponding edging members 43.

The shade assembly 50 is located between the upper rail 30 and the lower rail 40, and has a shade 51 which may be a beehive slat, Venetian blind slat assembly or pleated window shade. In an embodiment shown in the drawings, the shade 51 is a beehive slat with an upper end and a lower end formed respectively a first coupling plate 52 and a second coupling plate 53 to attach to a lower end surface 35 of the upper rail 30 and an upper end surface 44 of the lower rail 40 to connect to the upper rail 30 and lower rail 40. The first and second coupling plates 52 and 53 and the shade assembly 50 of the beehive slat have respectively apertures 521 and 531 corresponding to the first and second through holes 33 and 34 of the upper rail 30.

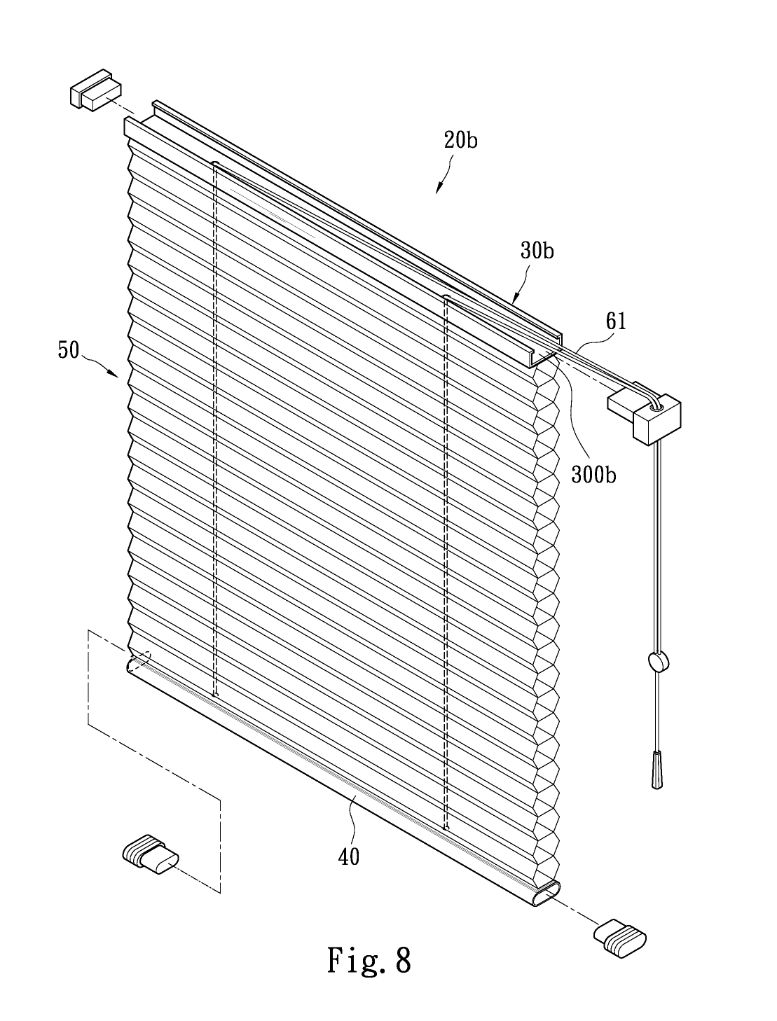

Also referring to FIGS. 4A and 4B, the lift cord means 60 includes a lift cord assembly which, in this embodiment, has two lift cords 61 with one end fastened to the lower rail 40 and the other end threading through the apertures 521 and 531 of the first and second coupling plates 52 and 53 and the upper rail 30, and laid outside the upper rail 30 (or as depicted in yet another embodiment shown in FIG. 8, having an open upper rail 30b, two lift cords 61 with one end fastened to the lower rail 40 and the other end threading through the shade assembly 50 and the upper rail 30b and laid in a channel 300b such that the lift cords 61 can be drawn outside the upper rail 30b before cutting the upper rail 30b). Then the lift cords 61 thread through an orifice 722 leading to a housing compartment 721 and pass through an engaging means 73 that are formed in the coupling set 70 (to be further discussed below).

Also referring to FIGS. 4A and 4B, the coupling set 70 is fastened to one opening 32 at one side of the channel of the upper rail 30 and has a latch portion 71 at one side facing the upper rail 30. The latch portion 71 has a hole (not shown in the drawings) leading to the housing compartment 721 and is abutting a holding portion 72. In this embodiment of the invention, the holding portion 72 is located on a corresponding outer side of the latch portion 71. The holding portion 72 has the housing compartment 721 inside and the orifice 722 on an upper side leading to the housing compartment 721. The housing compartment 721 holds the engaging means 73 which has a roller 731 at one side and a gear rack 732 inclinedly located at the other side engaging with a movable gear 733. The roller 731 and movable gear 733 form a passage 734 between them to allow the two lift cords 61 to pass through via the orifice 722 of the coupling set 70.

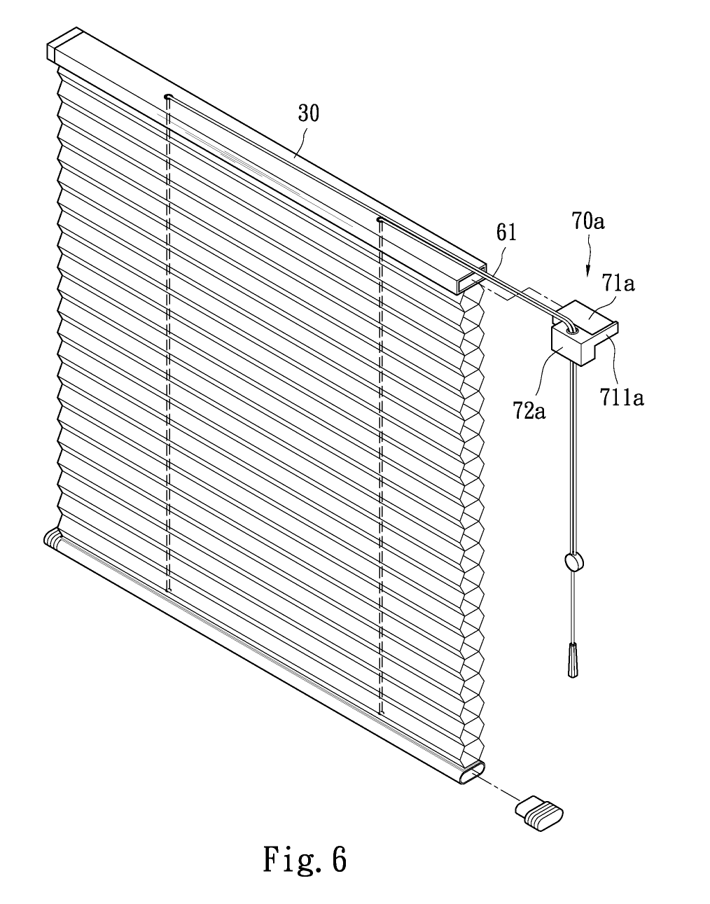

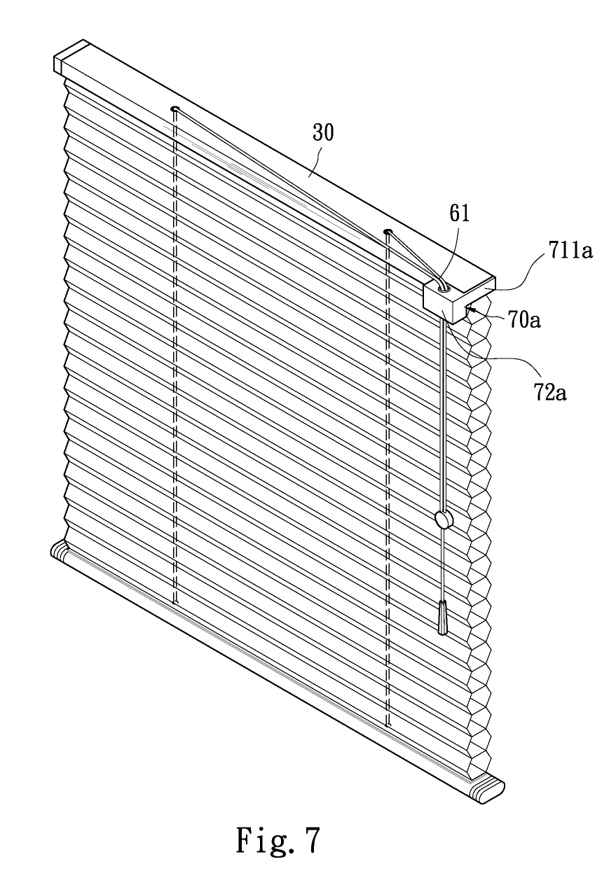

Referring to FIGS. 6 and 7, another type of coupling set 70a is provided that is wedged and located at one side of the upper rail 30. Such a structure also allows the two lift cords 61 to be laid above the upper rail 30. The coupling set 70a has a latch portion 71a at one side and a connecting element 711 a on an outer side extended to form a holding portion 72a adjacent to the latch portion 71a. The holding portion 72a also holds an engaging means (not shown in the drawings). Disassembly and installation of the coupling set 70a is the same as the coupling set 70 previously discussed.

Referring to FIG. 4A, when the invention is adopted on the window covering 20 with the shade assembly 50 of the beehive slat, the latch portion 71 at one side of the coupling set 70 is latched with one upper opening 32 of the upper rail 30, and the other upper opening 31 is coupled by the edging block 80. The two lower openings 41 and 42 of the lower rail 40 are wedged in respectively by one edging member 43, thus forms the window covering 20 of the invention.

When users procure the window covering, they can select the upper rail and lower rail slightly longer than the width of the targeted window or door if no exact fitting one is available. Then the chosen window covering can be cut as discussion below by referring to the embodiment shown in FIGS. 4A and 4B.

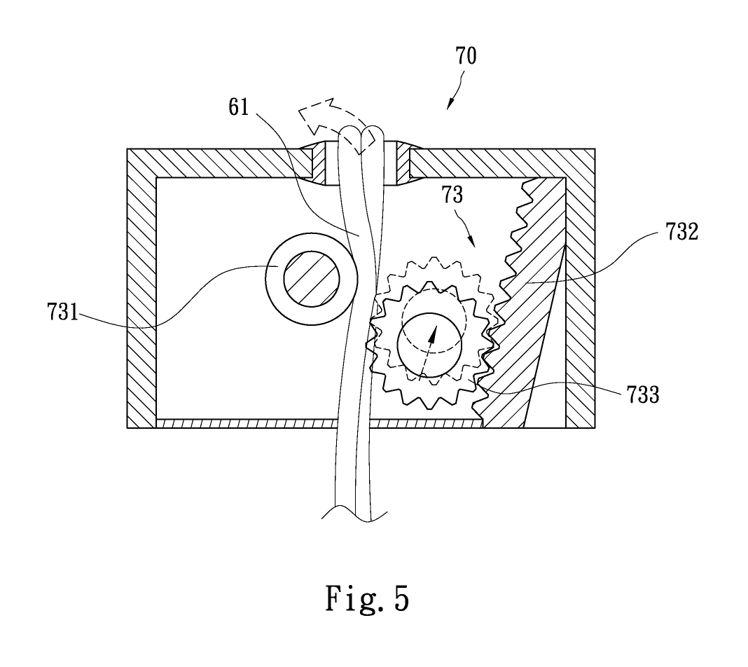

During installation of the beehive window covering 20 on the targeted window or door, pull the two lift cords 61 downwards in a loose condition without being clamped by the movable gear 733 and the roller 731 (referring to FIG. 4B), then draw the coupling set 70 from one side of the upper rail 30 and move over the two lift cords 61; cut the shade 51 and the upper rail 30 and lower rail 40 according to a desired width to fit the targeted window or door; wedge the latch portion 71 in the upper opening 32 of the upper rail 30; pull the lift cords 61 upwards so that they are clamped by the movable gear 733 moved upwards to engage with the inclined gear rack 732 and the roller 731 in an anchor condition (referring to FIG. 5). Finally, the edge block 80 and two edging members 43 are coupled in two sides of the upper rail 30 and lower rail 40. The resulting width of the window covering 20 can fit the width of the targeted window or door.

What is claimed is:

1. A window covering for convenient cutting, comprising:
an elongated upper rail having a channel inside;
a lower rail spaced from the upper rail at a lower side;
a shade assembly located between the upper rail and the lower rail;
a coupling set which is installed on an opening formed at one side of the channel and has a latch portion facing the upper rail and a holding portion abutting the latch portion to hold an engaging means; and
a lift cord means having a lift cord assembly which has one end fastened to the lower rail and the other end threading through the shade assembly and the upper rail and passing through the engaging means in the coupling set.

2. The window covering of claim 1, wherein the shade assembly has a shade which is selected from the group consisting of a beehive slat, a Venetian blind slat assembly and a pleated window shade.

3. The window covering of claim 2, wherein the shade has an upper end and a lower end formed respectively a first coupling plate, a second coupling plate and apertures threaded through by the lift cord assembly.

4. The window covering of claim 1, wherein the holding portion of the coupling set has a housing compartment, the engaging means including a roller located at one side of the housing compartment, a gear rack inclinedly located at the other side of the housing compartment and a movable gear engaging with the gear rack, the roller and the movable gear forming a passage therebetween to allow the lift cord assembly to pass through the coupling set and the passage of the engaging means.

5. The window covering of claim 4, wherein the housing compartment has an orifice located on an upper side communicating therewith.

6. The window covering of claim 5, wherein the lift cord assembly has one end fastened to the lower rail and the other end threading through the shade assembly and the upper rail and being laid outside the upper rail to pass through the orifice and the engaging means.

7. The window covering of claim 4, wherein the latch portion has a hole leading to the housing compartment of the holding portion.

8. The window covering of claim 7, wherein the lift cord assembly has one end fastened to the lower rail and the other end threading through the shade assembly and the upper rail and laid in the channel to pass through the orifice and the engaging means.
